(19) United States
(12) Patent Application Publication
(10) Pub. No.: US 2005/0096945 A1
(43) Pub. Date: May 5, 2005

(54) Method of administering automobile insurance premium finance contract asset-backed securities

(76) Inventor: Arthur L. Wharton III, Washington, DC (US)

Correspondence Address: Arthur L. Wharton, III, 2123 Branch Avenue, SE, Washington, DC, 20020, US

(21) Appl. No.: 10/979,278

(22) Filed: Nov. 3, 2004

Related U.S. Application Data
(60) Provisional application No. 60/516,756, filed on Nov. 4, 2003.

(51) Int. Cl. G06F 17/60

(52) U.S. Cl. 705/4

(57) ABSTRACT

The improved fiscal method in which automobile insurance premium finance contract asset backed securities (ABS) use the automobile insurance premium finance contracts as the underlying collateral for the ABS. The automobile insurance premium finance contract is an asset because it is associated with the right to receive cash flows. The securities would be short-term, medium-term or long-term debt instruments. Using automobile insurance premium finance contract asset backed securities will provide a continuous supply of lower cost capital from the capital markets to premium finance companies that provide a financial means in which the automobile insurance premium contracts to the consumers and businesses that finance automobile insurance premiums. With this steady supply of lower cost capital from the capital markets, the actual rates charged on automobile premium finance contracts to consumers and businesses could decline. This process can be implemented manually and/or electronically via computer by a LAN or WAN.

Priority is claimed to U.S. Provisional Application No. 60/516,756 file in the United States on Nov. 4, 2003, herein is incorporated by reference.

### BACKGROUND OF THE INVENTION

1. Field of the Invention

The present invention relates to an asset-backed security (ABS). More specifically, the invention is an automobile insurance premium finance contract asset-backed security that uses automobile insurance premium finance contracts as the underlying collateral for the securities. The securities would be short-term, medium-term or long-term instruments. This process can be implemented in a general or specific purpose computer, or over a distributed network, either public or private. Using automobile insurance premium finance contract asset-backed securities will provide a continuous supply of lower cost capital from the capital markets to premium finance companies to finance the insurance contracts to consumers and businesses that finance automobile insurance premiums. With this steady supply of lower cost capital from the capital markets, the actual rates charged on automobile premiums to consumers could decline. This decline in rates will result in more affordable insurance coverage.

2. Description of the Related Art

Asset-backed securities (ABS) have surfaced as a vital and rapidly emergent sector in the fixed income marketplace since its growth in the mid-1980's. Jayant Kumar, Insurance Asset Relationship Manager, from Brown Brothers Harriman, Insurance Asset Management Company, stated in his Jun. 25, 2003, article title, ABS Overview, that the attractiveness of these types of securities, usually with a high degree of protection, to both investors and issuers has led to very rapid growth. The total market value of new ABS issuance now exceeds $375 billion globally, and has been growing steadily over the last five years. The ABS marketplace is well established, particularly within the credit card, auto, and home equity loan sectors.

ABS are fixed income securities that derive their creditworthiness from the performance of an isolated collateral pool, not from the sponsor or originator of the underlying assets. ABS are usually issued through a trust that is a separate and distinct legal entity from the seller of the assets (i.e. the issuer). The establishment of the trust protects investors from insolvency or bankruptcy risk of the seller. Jayant Kumar also states that ABS typical legal structure is segmented into four parts: Seller/Services, Bankruptcy Remote Special Purpose Corporation (“SPC”), and Trust & Securities. This structure he say's, “allows a corporation to remove assets from its balance sheets and finance these assets at lower rates due to the higher credit of the trust”. The bulk of the issuance comes in the form of credit card, automobile and home equity loan ABS, but there are numerous other collateral types: manufactured housing, student loans, equipment loans, utility stranded costs, and recreational vehicles.

Currently, ABS marketable outstanding balance breaks down into the following sectors: Manufactured Housing—1.87%; Student loans—2.93%; Credit Cards—18.93%; Other—23.20%; Auto Loans—25.87% and Home Equity—27.20%.

As one can see from the overview, the ABS marketplace is well established. However, the marketplace does not specifically include a place for automobile insurance premium finance contract asset-backed securities (ABS). Therefore, a large market exists in which this type of ABS can be put into place. The automobile insurance premium finance contract ABS acts as the underlying collateral for the securities. The securities could be short-term, medium-term or long-term instruments. Leveraging this untapped sector, automobile insurance premium finance contract ABS will provide a process in which a continuous supply of lower cost capital from the capital markets go to premium finance companies for financing the insurance contracts to consumers and businesses that finance automobile insurance premiums. With this steady supply of lower cost capital from the capital markets, the actual interest rates charged on automobile premium finance contracts to consumers could decline. This decline in rates will result in more affordable automobile insurance coverage. These finance contracts are typically for one-year automobile insurance policies of persons who have poor driving records, or labeled “at risk” and are unable to get insurance coverage from mainline standard insurance carriers.

Insurance Finance & Investment, v3, nil; copyright Jun. 1, 1998, title “Is Low Severity/High Frequency Risk the Next Securitization Trend”, forecast that automobile insurance policies might become the next wave of insurance risk to be securitized. This new market likely would resemble the mortgage or asset-backed securities (ABS) markets. Insurers would set up special-purpose vehicles to issue the bonds on a regular basis. The bonds would tend to have predictable cash flows, based on the frequent but small losses of the underlying book of insurance business. This article focused on the securitization of the actual “risk of loss” insurance companies insure against. Venture, v8n1, PP: 72, 74, January 1986, titled “Selling Car Loans, Not Cars” by Jay Pridmore discloses a wall street investment banker, Anderson, who used his own contacts with large dealerships as a car insurance agent to become one of the first entrepreneurs to build a business around asset-backed securities (ABS)—debt instruments backed by proceeds from specific revenue streams, such as receivables, leases, and natural resources. Since December 1984, Anderson has sold 7 packages worth $100 million to institutional investors. His offerings could total $30 million-$50 million per month. Banks, pension plans, and savings and loans seek these asset-backed securities because they are secure and provide a higher yield than government bonds. U.S. Pat. App. Pub. No.: 2003/0105696 A1 to Kalotay et al., describes a method and/or apparatus for modeling and administering asset-backed securities using coupled lattice efficiency analysis. More specifically, Kalotay et al., discloses new tools for modeling prepayment of principal by obligators behind asset-backed securities. The obligators are categorized into groups for ordered removal from the modeling and valuation process according to their refinancing efficiency. These tools can be used in a couple-lattice recursive analysis process to obtain the value of asset-backed securities such as mortgage-backed securities and like obligations.

None of the above non-patent literature, patents, and/or prior art, taken either singly or in combination, is seen to describe the subject's method of having an automobile insurance premium finance contract ABS which discloses the instant invention as claimed. Thus a business method for the aforementioned problems is desired.

### SUMMARY OF THE INVENTION

The invention relates generally to an asset-backed security (ABS). Accordingly, it is the principal object of the invention to use automobile insurance premium finance contract asset-backed securities to lower the cost of capital to premium finance companies. This decline in rates could result in more affordable automobile insurance coverage due to lowering the cost of capital to premium finance companies.

It is another object of the invention to securitize automobile insurance premium finance contracts that are typically one-year automobile insurance policies for people that are “high risk” i.e., have poor driving records and are unable to get insurance coverage from mainline standard insurance carriers. These automobile insurance premium finance contracts typically have interest rates that are on the order of 20% plus. Because automobile insurance is required by all states, there is a steady market for these policies and the contracts that finance their purchase.

It is further an object of the invention to create an ABS that uses automobile insurance premium finance contracts as the underlying collateral for the securities.

Still another object of the invention is to create securities that are short-term, medium-term or long-term instruments.

It is an object of the invention to provide an improved fiscal method and arrangement for lowering the cost of insurance premiums for “high risk” customers, in which, automobile insurance premium finance contracts are assets of the premium finance companies that facilitate provision of automobile insurance for persons having poor driving records. This process can be implemented electronically via computer over a Local Area Network (LAN) or a Wide Area Network (WAN).

For the objectives described, high-risk customers will be able to afford automobile insurance that can potentially be less expensive, dependable and fully effective in accomplishing its intended purposes.

These and other objects of the present invention will become readily apparent upon further review of the following specification and drawings.

### BRIEF DESCRIPTION OF THE DRAWINGS

The accompanying drawings illustrate a preferred complete embodiment in the present invention, to which it is not limited as shown in the accompanying figure.

FIG. 1 is a block diagram or flow chart illustrating the various steps involved in establishing an improved method of using automobile insurance premium finance contracts asset-backed securities (ABS).

FIG. 2 is a block diagram illustrating current operations of automobile insurance premium finance methods.

FIG. 3 shows an apparatus functioning in a network according to the present invention.

Similar reference characters denote corresponding features consistently throughout the attached drawings.

### DETAILED DESCRIPTION OF THE PREFERRED EMBODIMENT

The present invention introduces a new approach to utilizing automobile premium finance contracts for insuring automobiles. These contracts are used as collateral for asset-back securities that allow this novel approach to work. This approach is novel because investment bankers and financers who create and underwrite securities have not capitalized on this market or segment of the economy that utilizes automobile insurance premium finance contracts to insure automobile owners, and hence, have not developed any ideas on securities that would address the dynamics and opportunities that it provides. The present invention is necessary because it addresses the dynamics and opportunities in this market.

The present invention is a type of asset back security that uses automobile insurance premium finance contracts as the underlying collateral for the securities. These securities would be short-term, medium-term or long-term debt instruments. Short-term is defined as maturities less than 1 year. Medium-term is defined as maturities between 1 and 10 years. Long-term is defined as maturities more than 10 years.

These premium finance contracts are typically for one-year automobile insurance policies of persons who have poor driving records and are unable to get insurance coverage from mainline standard insurance carriers. The interest rates charged on these contracts are generally the highest allowable by state usury laws. These rates rival credit card interest rates on the order of 20% plus.

Because automobile insurance is required by all states, there is a steady market for these policies and the contracts that finance their purchase. These policies are called non-standard personal auto insurance, which amount to approximately 20% of the personal insurance market. The total annual premiums for the personal non-standard market amount to approximately $20 billion. Premiums are financed by premium finance companies that have an association with individual insurance agencies and insurance carriers. Approximately $20 to $25 billion in insurance premiums is financed annually.

Using automobile insurance premium finance contract asset-backed securities will provide a continuous supply of lower cost capital from the capital markets to premium finance companies to finance the insurance contracts to consumers and businesses that finance automobile insurance premiums. With this steady supply of lower cost capital from the capital markets, the actual interest rates charged on automobile premium finance contracts to consumers could decline. This decline in rates will result in more affordable automobile insurance coverage.

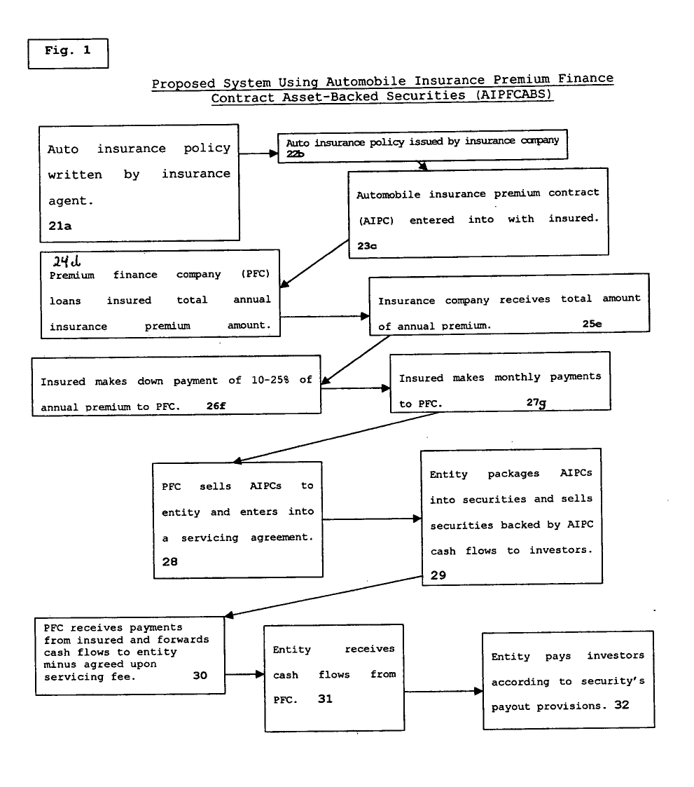

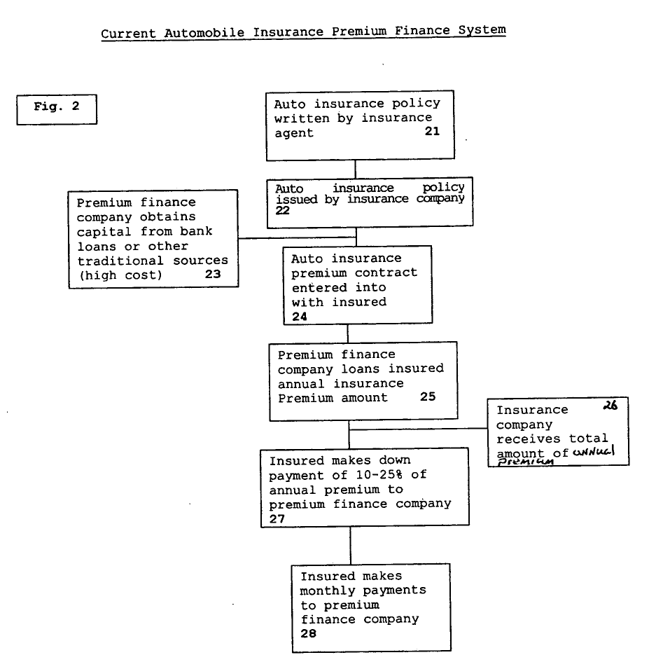

FIG. 2 illustrates a basic flow diagram of an existing method of implementing an automobile insurance premium finance system. The steps are as follows: The insurance agent writes an Automobile Insurance Policy 21, which is issued by the insurance company 22, a Premium Finance Company in which capital is obtained from bank loans or other traditional sources at a higher cost 23. An automobile insurance premium finance contract is entered into between the insured 24, and the Premium Finance Company for the annual automobile premium amount 25. The Insurance Company involved receives the total amount of the annual premium 26. The insured makes down payment of 10-25% of the annual premium to the premium finance company 27. In addition, the insured makes monthly payments to the premium finance company 28. FIG. 1 is a flow diagram of the said improved method of implementing an automobile insurance premium finance contract having asset-backed securities. Steps 21a-27g are said existing methods within FIG. 2, steps 21,22, 24-27. The said improved methodology takes place starting with step 28 in which a Premium Finance Company sells Automobile Insurance Premium Finance Contracts (AIPFCs) to a special purpose entity (SPE) and enters into a servicing agreement. The entity i.e., special-purpose entity, special-purpose financing vehicle or special-purpose corporation packages AIPFCs into securities backed by AIPFC cash flows and sells securities backed by AIPFC cash flows to investors 29. A premium finance company (PFC) receives payments from the insured and forwards cash flows to the SPE minus agreed upon servicing fee 30. SPE receives cash flows from PFC 31. SPE pays investors according to the security's payout provisions 32.

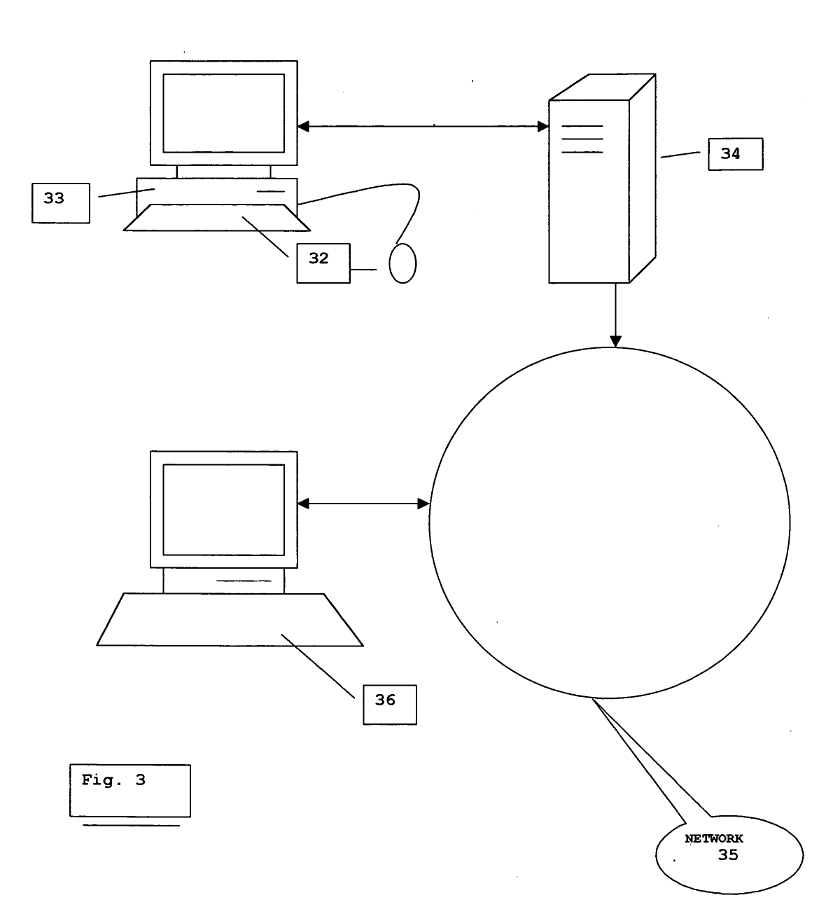

The present invention can be implemented in a general or specific purpose computer, or over a distributed network, either public of private as illustrated in FIG. 3. In FIG. 3, a computer 33, such as a personal computer, mainframe or any other computer capable of carrying out the present invention is connected to input devices such as a keyboard and mouse 32, IR ports, etc. The computer 33, e.g., (the insurance agent or insurance company) can optionally be connected to a server 34, or have a server function that is accessible from a network 35, either private or public, e.g., the Internet, connected to other users 36. In this manner, all steps in the process can be written through routine programming techniques and implemented electronically via a LAN or WAN. Users 36, (i.e., the Insured or Investor) are able to correspond with the Premium Finance Company (PFC) to receive payment or payout provisions. The present invention can also be embodied as a computer readable media, such as but not limited to magnetic optical or other type of storage devices (regardless of whether it is a RAM or ROM type), as well as transmissions of signals and data over public and private networks, etc. Once loaded on a user's computer or a computer accessible to the user, the method as described herein usable, at least in part by user.

It is to be understood that the present invention is not limited to the embodiments described above, but encompasses any and all embodiments within the scope of the following claims:

1. An improved computer implemented fiscal method of administering automobile insurance premium finance contracts comprising the steps of:
a. directing premium finance companies to sell automobile insurance premium contracts to special purpose entity and entering into a servicing agreement;
b. packaging electronically automobile insurance premium contracts into securities by special purpose entities in which said securities are backed by automobile insurance premium contract cash flows and sold to investors as assets;
c. receiving payments electronically from an insured party in which payments are forwarded to said asset-backed security issuing entities minus an agreed upon servicing fee;
d. collecting cash flows for special purpose entities from said premium finance companies;
e. distributing payments from said special purpose entities to asset-backed security investors in accordance with the Automobile Insurance Premium Finance Contract Asset-Backed Security's payout provisions.

2. The improved computer implemented fiscal method according to claim 1, wherein said Automobile Insurance Premium finance contracts are manually packaged into securities by special purpose entities in which said securities are backed by Automobile Insurance Premium Finance Contract and sold to investors.

3. The improved computer implemented fiscal method according to claim 2, further comprising Automobile Insurance Premium Finance Contract that function as the underlying collateral for Automobile Insurance Premium Finance Contract Asset-Backed Securities.

4. The improved computer implemented fiscal method according to claim 3, wherein Automobile Insurance Premium Finance Contract Asset Backed Securities are short-term, medium-term or long-term instruments.

5. The improved computer implemented method according to claim 4, further including shot-term instruments having maturities from one year or less; medium-term instruments from 1 year up to 10 years; long term instrument having maturities greater than 10 years.

6. The improved computer implemented fiscal method according to claim 3, wherein said Automobile Insurance Premium Finance Contract Asset Backed Securities lower the cost of capital to premium finance companies.

7. The improved computer implemented fiscal method according to claim 3, wherein said Automobile Insurance Premium Finance Contracts are assets that generate cash flows.
